(19) United States
(12) Patent Application Publication
(10) Pub. No.: US 2024/0119427 A1
(43) Pub. Date: Apr. 11, 2024

(54) INTELLECTUAL PROPERTY MANAGEMENT SYSTEM - INTELLECTUAL PROPERTY BLOCKCHAIN-PLATFORM

(71) Applicant: Viktor Vladimirovich LAKHTIN, Orenburgskaya obl., g. Novotroitsk (RU)

(72) Inventor: Viktor Vladimirovich LAKHTIN, Orenburgskaya obl., g. Novotroitsk (RU)

(21) Appl. No.: 17/961,679

(22) Filed: Oct. 7, 2022

(51) Int. Cl. G06Q 20/06; G06Q 50/18

(52) U.S. Cl. CPC G06Q 20/065; G06Q 50/184; G06Q 2220/10

(57) ABSTRACT

The invention relates to an intellectual property (IP) management system. The technical result is to provide automated IP management. The system comprises a cryptocurrency exchange, computers with software based on a blockchain-platform having an electronic IP bank that is connected with world databases for IP object registration. The blockchain-platform is configured to provide an automated international search for IP objects through the electronic IP bank, obtain information about analogues of an IP object, draw up the IP object in the electronic IP bank, and register the IP object at the international level. The system is configured to manage IP objects based on smart-contracts and comprises: a unit for storing the smart-contracts along with IP object management conditions for a counterparty; a unit for storing questionnaires about an IP object owner; a unit for storing IP objects and identification codes assigned to each IP object.

### CROSS-REFERENCE TO RELATED APPLICATIONS

The present patent application claims priority to Russian application 2019107727 filed on Mar. 18, 2019 currently issued as a patent 2702976 on Oct. 14, 2019, all of which incorporated herein in its entirety.

### FIELD OF THE INVENTION

The invention relates to the field of computer technology for receiving and transmitting intellectual property data and transactions, in particular to systems for managing intellectual property objects (IPOs) stored in computer systems.

### BACKGROUND OF THE INVENTION

US 2016292672 (6 Oct. 2016) discloses a blockchain-platform comprising a structured database that enables transactions between users. This blockchain-platform is a computer system that communicates with a computing system having a distributed blockchain that includes several computing nodes. An exchange stores an order book and multiple digital wallets associated with different clients. The computer system receives new data transaction requests that are added to the order book. A match is identified between the data transaction requests and the hashes relating to the digital wallets associated with the corresponding data transaction requests. Counterparties receive the hashes of the other party along with the match information, and each party causes blockchain transactions to be added to the blockchain of the computing blockchain-system. The computing system then monitors the blockchain to determine if both parties of the match have been added to the blockchain.

However, the above platform does not provide information decentralization and distribution, which contributes to an increase in labor costs and time for data processing.

### SUMMARY OF THE INVENTION

The technical problem to be solved by the proposed invention is to expand the arsenal of software and hardware products having parameters and characteristics which enable extended functionalities in IPO management.

The technical result achieved by implementing the invention is to expand the arsenal of technical means (there is a single IPO bank with all data, where one can see real information with all changes; a specialized IPO exchange) by protecting the right to IPOs at the place of their registration, simplifying the organization, systematization and management of the IPOs, reducing labor costs and increasing the operating efficiency of a blockchain-platform and the speed of finding, selecting and comparing the IPOs (a PIP platform allows potential IPO owners to conduct an international search automatically through an intellectual property bank, learn about IPO analogues, and correctly draw up the IPOs in the electronic intellectual property bank; the PIP platform will also allow one to instantly register the IPOs at the international level (since the platform will be connected with all IPO registration platforms in the world), as well as to perform decentralized workflow management based on the IPO blockchain-platform, thereby allowing one to quickly track any changes in information on the IPOs, the legal effect of the IPOs, the status of the IPOs, disposal, etc., and facilitating the management of intellectual property assets, licensing, payment tracking, etc.

The above-indicated technical result is achieved by an intellectual property (IP) management system based on a cryptocurrency blockchain-platform. The system comprises a cryptocurrency exchange and one or more user computing devices provided with software based on the PIP platform having an electronic IP bank that is associated with world databases for IP object registration. The system is configured to manage IP objects based on smart-contracts and comprises: a unit for storing the smart-contracts along with IP object management conditions for a counterparty; a unit for storing questionnaires about an IP object owner; a unit for storing IP objects and identification codes assigned to each of the IP objects, which is connected to a webpage for displaying information about each IP object. The webpage is configured to record information about legal changes of the IP object and display, by means of smart-sending, information on the IP object management conditions from the smart-contract storage unit. The electronic IP bank has a cataloger and is configured to activate a smart-contract, search for potential counterparties (buyers/users/listeners) and transfer IP objects based on an agreement in exchange for an electronic monetary unit (tokens, coins) by sending a command comprising the smart-contracts to an Ethereum platform in a convenient and understandable interface and sending the monetary unit to an electronic payment system of an agent, an insurance fund and the IP object owner. The monetary unit is assigned a code identical to the identification code of the IP object in the cataloger. Each monetary unit is issued in the electronic IP bank, is associated with the cryptocurrency exchange, and is configured to be automatically indexed depending on the legal status of the IP object.

The cryptocurrency blockchain-platform is configured to store and exchange data in a distributed computing network and has an Internet site. By using this blockchain-platform openly, directly or through a personal account, it is possible to work with all interested parties, trade an IPO asset and register the IPOs in different countries. This platform will simplify and speed up the international search for IPO analogues, as well as reduce the cost of IPO registration.

The cryptocurrency blockchain-platform refers to a distributed IPO database that maintains an ever-growing log or register protected from forgery and hash-based verification.

By using the PIP platform, the cryptocurrency blockchain-platform will allow the IPOs to be registered in the cataloger of the electronic IP bank, while assigning the IPO an identification code that matches the identifier of the monetary unit of the server computing systems of the cryptocurrency exchange and is entered into the distributed database of the information system (the database of the server computing system of the electronic IP bank, the database of the server computing system of the cryptocurrency exchange and user computing devices). The IPOs are entered into the distributed register of the information system, where the smart-contract for the IPOs is registered, thereby significantly reducing the time required to register the right to dispose of the IPOs and simplifying the procedure for IPO management.

Any information about the IPOs in the distributed database of the information system is published as a new data block/package. Each data block comprises a link to a previous data block.

Each server computing system and each computing device can send data to and receive data from the data network through a network connection.

By using the (public) blockchain technology, it is possible to store and coordinate all information about the IPO, its legal status, production, any actions associated with it (alienation, licenses, litigation, pledge, etc.), i.e., store information about every action/operation on the IPO in the distributed database of the information system. Every action on the IPO is recorded and stored, with a new PIP platform-controlled information package being subsequently added to the blockchain of the database of the information system. All information about the IPO, which can be displayed on the webpage, is stored and updated for each user of the system, on the server computing system of the electronic IP bank and the server computing system of the cryptocurrency exchange. This information is delivered to the users via the PIP platform to the execution units (storage unit, transmission unit, processing unit data) of the user computing devices, the server computing system of the electronic IP bank and the server computing system of the cryptocurrency exchange, and this information is subsequently processed and prepared for storage in the distributed database of the information system with the ability to track all actions, transactions that took place in the system.

The IP management system based on the cryptocurrency blockchain-platform comprises one or more user computing devices (a smartphone, a personal computer, a laptop, a tablet or any other computing device programmed to execute computer program instructions) based on the PIP platform which are configured to store a blockchain, and a cryptocurrency exchange which is a platform for online trading and exchange of cryptocurrencies on the Internet and comprises a server computing system having one or more processors with software based on the PIP platform. The processor(s) is(are) programmed to perform the operations of:
displaying the monetary unit issued in the blockchain-platform;
managing the monetary unit of the IPO;
displaying information about changes in the IPO with reference to changes in the pricing (value) of the monetary unit of the IPO;
selling, leasing the IPO for any type of monetary units, including cryptocurrency.

The cryptocurrency exchange is created for any disposal of all IP types.

The electronic IP bank is a server computing system connected to the world databases for IP object registration and configured to manage the IP objects based on the smart-contracts. The server computing system comprises one or more processors with software based on the PIP platform, which is(are) programmed to perform the operations of:
storing, on one or more machine-readable storage media, information about the IPOs in the IPO storage unit in the cataloger;
drawing up and storing the questionnaires about the IPO owner in the questionnaire storage unit;
concluding a smart-contract for the IPOs with a user, while indicating the IPO management conditions according to the questionnaire, and storing the smart-contract in the smart-contract storage unit;
managing the IPOs based on the smart-contract, while assigning a disposal price for the IPOs;
assigning each IPO the identification code in the cataloger that is associated with the blockchain-platform;
performing transactions and activating the smart-contract on the blockchain-platform;
searching for potential counterparties (buyers/users/listeners) and transferring the IPOs based on an agreement in exchange for the electronic monetary unit (tokens, coins) by sending the command with the smart-contracts to the Ethereum platform in the convenient and understandable interface that displays information about the legal status of the IPOs and sending the monetary unit to the electronic payment system of the agent, the insurance fund and the IPO owner with the assignment of an identifier (code) to the monetary unit that is identical to the identification code of the IPO in the cataloger, wherein every monetary unit is issued in the electronic IP bank, is associated with the cryptocurrency exchange and is configured to be automatically indexed depending on the legal status of the IP object;
assigning a link (referral link) to the smart-contract to redirect it to the execution unit of the user computing device;
depending on the IPO, assigning the IPO in the cataloger the identification code (for example, an alphanumeric code) that matches the identifier of the monetary unit;
interacting with the server computing system of the insurance fund.

The IP bank is the only place where all information about the IPOs and their further change will be stored. The IP bank allows one to register the IPOs. All information about the IPOs from the IP bank goes to the cryptocurrency exchange. Information posted on the exchange in the IP bank allows users (agents, lawyers, attorneys, enterprises, government entities, etc.) to carry out certain work on the use and change of the IPOs.

The server computing system of the electronic IP bank is connected to the webpage for displaying information about each IP object. The webpage is configured to record information about legal changes in the IP object and display, by means of smart-sending, information about the IP object management conditions from the smart-contract storage unit, in particular, the conditions for the disposal of the IPOs, their cost, any information changes, starting from the IPO type (patent, copyright, etc.) and all information for the entire period from their registration to the present and ending with any actions, changes, etc.

The questionnaire is filled out individually depending on the type of the IPOs (works of science, literature and art; programs for electronic computing machines (computer programs); databases; performances; phonorecords, communication on the air or by cable of radio or television programs (broadcasting of on-air or cable broadcasting organizations); inventions; utility models; industrial designs; selection achievements; topologies of integrated circuits; production secrets (know-how); trade names; trademarks and service marks; appellations of origin; commercial designations).

Each user computing device comprises an execution unit configured to follow the referral link to the electronic IP bank and interact with the blockchain-platform for tokenizing the IPOs and placing the IPOs in the IP bank by receiving and transmitting information about the user and the IPOs among the users via the PIP platform which is configured to register the IPOs at the international level. The PIP platform is also connected with the server computing systems of the cryptocurrency exchange and the electronic IP bank to receive/send monetary units (coins, tokens) through the blockchain-platform, as well as to activate the smart-contract of the electronic IP bank on the blockchain-platform to receive the tokens/coins (ticker—IPC) in the user electronic wallet (for example, the electronic payment system of the agent, the insurance fund, and the IP object owner).

### BRIEF DESCRIPTION OF THE DRAWINGS

FIG. 1 shows a schematic block diagram of the claimed intellectual property management system—intellectual property blockchain-platform.

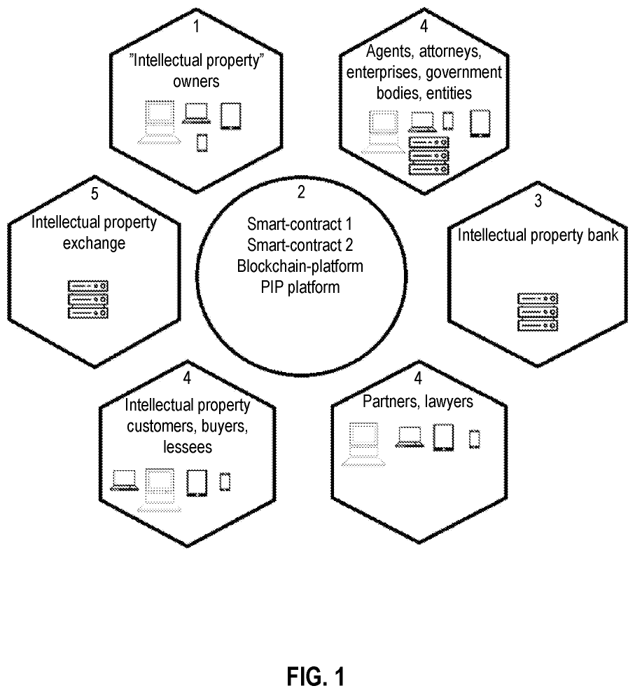

### DETAILED DESCRIPTION OF THE INVENTION

The claimed invention is illustrated by the following example.

By using a computing device 1 of a user (in this case, an owner), information about an IPO (i.e., which type it belongs to, its expiration date, who is its owner, author, its cost, etc.) is tokenized through a blockchain-platform 2 into a cataloger (into an IPO storage unit, a questionnaire storage unit) of a database of a server computing system 3 of an electronic IP bank. In the database, each IPO is assigned an identification code, which is entered into the database of the server computer system 3 of the electronic IP bank. At the same time, the same code is assigned to a monetary unit of a cryptocurrency exchange and stored in a database of a server computing system in the cryptocurrency exchange.

The IP bank acquires, by means of a smart-contract, rights to IPOs in exchange for an electronic monetary unit (tokens, coins) by sending a command with smart-contracts to the Ethereum platform in a convenient and understandable interface and sending the monetary unit to an electronic payment system of the IP object user-owner.

The IP bank stores information on the acquisition of the IPOs in a unit for storing IP objects with IPO management conditions coming from a smart-contract storage unit. All information about the IPOs, actions on them, etc., is simultaneously updated and reflected by a PIP platform in the distributed database of the information system: on a webpage, in the IP bank and on the cryptocurrency exchange, as well as for the IPO user-owner, by using the servers of the IP bank and cryptocurrency exchange and the user computing device (i.e., servers/processors of all participants of the process, including an agent and an insurance fund), which take part in the IPO-associated chain “acquisition/disposal/pledge/litigation, etc.” and which are connected using the blockchain technology in real time. Each monetary unit is issued in the electronic IP bank, is associated with the cryptocurrency exchange, and is configured to be automatically indexed depending on the legal status of the IPOs.

The IP bank, which has IP from all over the world, is entitled to give them away, sell them, i.e., it has the right to IP under a contract, can dispose of it in agreement with an IP owner according to smart-contract No. 1. The disposal price of the IP may differ from its original price.

According to the conditions stipulated based on the charter of the IP bank, the IP bank is entitled to grant the right to use one or another IPO to interested parties (potential buyers).

The right to use the IPO is stipulated in smart-contract No. 1 when an IP right holder places the IP in the IP bank. Correspondingly, he/she simultaneously stipulates conditions according to the questionnaire of the IP bank, which differs depending on the IPO.

The IP user-owner enters, by using the execution unit of the computing device 1, information into the IP bank through a questionnaire which contains all the conditions that, in his/her opinion, are acceptable for the IP to be transferred to the use of some counterparty. In other words, he/she says that he/she (IP owner) deposits his/her IP in the IP bank, receives payment for the IPO which will be sold at the price indicated by the IP owner in the smart-contract. This recommendation is entered into an IP page, which opens in the IP bank, for each IPO. The page (webpage) is on the Internet, on the site where all information about this IPO and any changes in the information, starting from a patent (all intellectual property types) and all other information for the entire period from the IPO registration till present and ending with any IPO transfers, changes, etc., are constantly displayed/updated. On this site, there are also recommended conditions for using this IPO. All this information is displayed using the blockchain technology, to which the computing devices and servers of all participants of the process are connected in real time. In return, the IP owner receives what was previously agreed in the smart-contract—this is done by means of smart-sending to the IP bank.

After the IP bank transfers electronic monetary units (tokens, coins) to the electronic payment system of the IP owner, the IP bank gives a command to use the Ethereum-type IP platform. Smart-contracts No. 1 are present on the platform in the convenient and understandable interface.

Smart-contract No. 1 has already been activated by the IP user-owner, or alternatively, the IP bank gives the owner a link to smart-contract No. 1 which the IP bank has accordingly activated for him/her. The activation of smart-contract No. 1 occurs after the IP entered the IP bank and should be carried out from both sides (from the IP bank's side and from the IP owner's side). This is the starting point for smart-contract No. 1. The smart-contract is activated on the blockchain-platform.

Each IPO is assigned its own personal monetary units (hereinafter referred to as tokens) on the cryptocurrency exchange, which can be purchased by any third parties through processors, servers or computing devices. Thus, the third parties become, for the IPO they are interested in, participants in the chain of the blockchain technology-based system.

In order for the IP user-owner under the smart-contract to receive tokens, it is necessary to make payment in cryptocurrency—internal. There are two financial circles: an internal currency of the claimed system and a common currency which is an equivalent of everything, let us call it aupicon (ticker—IPIC, the maximum number of issued tokens is 10,000,000,000 or another number at someone's discretion).

The IP user-owner transfers, by using the electronic payment system, monetary units to user-agents 4 (patent attorneys, organizations, enterprises, lawyers, etc.). Each token is linked to the common currency “aupicon” of the blockchain-platform.

The IP user-owner immediately receives a monetary unit for the IPO and purchases tokens for this IPO on the cryptocurrency exchange, and he/she can sell his/her personalized tokens even before the sale of this IPO on the cryptocurrency exchange.

The IP owner receives, through the electronic payment system and a server computing system 5 of the cryptocurrency exchange, monetary units to his account, from which he/she returns a part of the monetary units to the IP bank. He/she also opens an additional account in an electronic wallet, to which the monetary units having a code identical to the code of this IPO in the cataloger of the IP bank are received specifically for this IPO.

The cataloger of the IP bank is deployed, where an alphanumeric code and every letter, number indicates which folder it is. Let “a” be inventions relating to petroleum products or ferrous metallurgy, “b” be a regular cataloger—consumer goods. Thus, the name of this monetary unit will be identical to the name of this depository.

Some of these monetary units (tokens, cryptocurrency units) is sent by the IP bank to the IP owner for any IPO, and some of these monetary units are received by a user-agent (for example, a patent attorney, lawyer, etc.), and some remain in the IP bank.

The IP owner came to this system via a referral link given to him/her by the user-agent. The IP owner, who has tokenized his/her IP in the IP bank, can sell the monetary units on the cryptocurrency exchange, and the IP bank, in order for the monetary units of the IP owner to be worth something on the cryptocurrency exchange, is actively engaged in searching for potential IPO buyers or users or listeners, etc.

Any person who has participated in the registration of an IPO in the IP bank, for example, the user-agent, also receives some of the monetary units of the IP user-owner after the smart-contract is activated. Also, the insurance fund receives a share of the monetary units of the IP user-owner (in this case, it will insure the entire system against accidents) through its server. The insurance fund is a separate entity. The rest of the payment is credited to the account of the IP bank.

The remaining monetary units (approximately 80% of coins) can be traded by the IP user-owner on the cryptocurrency exchange, even though the IPO has not been sold.

Each monetary unit entered into the blockchain-platform and issued in the blockchain-platform immediately appears on the cryptocurrency exchange, which is included in the system as an integral part thereof.

To exercise its rights to IPOs, the IP bank concludes another smart-contract No. 2 with any person (user-agents), for example, an initiator of IP sale, IP lease, a legal service provider, etc. This person is obliged to activate this smart-contract No. 2.

At the stage of IP disposal, new users-agents appear in this system, such as lawyers, enterprises, natural persons, sites of IP buyers that were still part of a content or some software, etc.

The new user-agents access the IP bank, seeing all the information on IP that is stored therein.

The PIP platform operates as follows. The user-agent (for example, a lawyer) receives, on his/her computing device, information about the registration of a new IPO from the IP bank. This user sees all the information about this IPO in the registry on the webpage, for example, the IP bank stores a certain patented invention, it displays information about its use by a third party (for example, an infringing company, etc.) (hereinafter referred to as the Company) without the consent of the IP bank.

To initiate a movement in the direction of filing a claim on behalf of the IP bank against this third party for the purpose of recovering funds from the third party, this user-agent (lawyer) needs to go to the blockchain-platform and activate the smart-contract concluded with him/her (hereinafter referred to as smart-contract No. 2). In this smart-contract No. 2, he/she fills in the code of that page under which the code of this IP appears, i.e., the same code as the name of the monetary unit. In response, a link to the wallet is sent to him/her. It is the wallet to which the monetary units should be sent. The link comprises information about the conditions for the use of the invention (IPO), for example, as a blank form, contract, offer.

The IP bank, which has the rights to this invention under the smart-contract concluded earlier with the user-owner, comprises an electronic payment system (electronic wallet), to which it is necessary to send a monetary unit for the use of this invention by the Company (third party). In the case of payment by the Company for the use of the invention, the monetary units “aupicon-IPIC” acquired by the Company will then go to smart-contract No. 2 in the IP bank.

The Company acquires these monetary units through its servers on the cryptocurrency exchange. A reward in the amount of a predetermined % in smart-contract No. 2 goes to the electronic payment system (for example, wallet) of the user-agent, and the rest is distributed among electronic payment systems (wallets) of participants in the process chain, i.e., among the user-owner, the users-agents, the IP bank acting as a depository, insurers, etc., in the proportions in which they all own these tokens.

The information is stored in activated smart-contract No. 1, on the servers of the IP bank and the IPO exchange.

The user-agent (lawyer) contacts the Company-infringer and asks to pay for the unauthorized use of the invention. If the Company refuses to pay, then the user-agent (lawyer) sues, while all the information (on claims, court proceedings, etc.) is entered into the distributed database of the information system by using the computing devices, servers of the companies and organizations participating in the chain of IPO workflow management, as well as into the webpage by using the blockchain technology to which the computing devices and servers of all the participants in the process are connected in real time, including the IP bank and most importantly the IPO exchange.

According to the results of consideration of the claim, the price of the token for this invention (IPO) may change on the cryptocurrency exchange.

There can be many owners of tokens for this invention since the IP user-owner could sell his/her tokens on the cryptocurrency exchange. In this case, dividends are distributed among all wallets.

Any person who sees an IPO in the IP bank can take part in the claimed system and can:
1. lease the IPO by paying for the lease, try the aspect of its production, etc., i.e., use the selected IP.
2. buy out the IP.

Any IP type will be put into operation in any form, and there will be information on each IP type on the cryptocurrency exchange. If information about IP began to change, then, respectively, on the cryptocurrency exchange the price of each token/coin that is issued for a certain IP type will rise or fall accordingly, and so on.

What is claimed is:

1. An intellectual property (IP) management system based on a cryptocurrency blockchain-platform, the system comprising:
a cryptocurrency exchange; and
one or more computers provided with software based on the blockchain-platform having an electronic IP bank that is associated with world databases for IP object registration;
wherein the blockchain-platform is configured to perform an automated international search for an IP object through the IP bank, obtain information about analogues of the IP object, draw up the IP object in the electronic IP bank, and register the IP object at an international level;
wherein the system is configured to manage the IP object based on smart-contracts and further comprises:
a unit for storing the smart-contracts along with IP object management conditions for a counterparty;
a unit for storing questionnaires about an IP object owner;
a unit for storing IP objects and identification codes assigned to each of the IP objects, which is connected to a webpage for displaying information about each of the IP objects;
wherein the webpage is configured to record information about legal changes of the IP object and display information on the IP object management conditions from the unit for storing the smart-contracts;
wherein the electronic IP bank has a cataloger and is configured to activate a smart-contract, search for potential counterparties (buyers/users/listeners) and transfer the IP object based on the smart-contract in exchange for an electronic monetary unit (tokens, coins) by sending a command comprising the smart-contracts to an Ethereum platform in a convenient and understandable interface and sending the monetary unit to an electronic payment system of an agent, an insurance fund and the IP object owner;
wherein the monetary unit is assigned a code identical to the identification code of the IP object in the cataloger; and
wherein each monetary unit is issued in the electronic IP bank, is associated with the cryptocurrency exchange, and is configured to be automatically indexed depending on a legal status of the IP object.
